(19) United States
(12) Patent Application Publication
(10) Pub. No.: US 2014/0039830 A1
(43) Pub. Date: Feb. 6, 2014

(54) TEST DEVICE TO MEASURE COATING THICKNESS AND TEST SYSTEM

(71) Applicants: HON HAI PRECISION INDUSTRY CO., LTD., New Taipei (TW); Fu Tai Hua Industry (Shenzhen) Co., Ltd., Shenzhen (CN)

(72) Inventor: SHI-YUN HUANG, Shenzhen (CN)

(21) Appl. No.: 13/939,615

(22) Filed: Jul. 11, 2013

(30) Foreign Application Priority Data
Aug. 6, 2012 (CN) 2012102768596

(51) Int. Cl. G01B 7/06

(52) U.S. Cl. CPC G01B 7/105; G01B 7/06
USPC 702/170

(57) ABSTRACT

A test device includes a test port, a storage unit, and a processing unit. The test port connects to a test line including a test probe. The storage unit stores a relationship table defining relationships between various thicknesses of coatings and readings from the test probe. The processing unit includes a detection module, a power control module, and a result analysis module. The detection module detects a test signal to start a test and continue for a period of time. The power control module provides power to the test port for the test period. The test probe produces a stimulus signal when receiving the power from the test port, and produces a feedback signal containing a reading when the power voltage is cut off. The result analysis module obtains the particular reading and determines the thickness of the coating according to the relationship table.

### BACKGROUND

1. Technical Field

The present disclosure relates to test devices, and particularly to a test device with a function of testing coating thickness and test system thereof.

2. Description of Related Art

Electronic devices such as smart phones and tablet computers are popular. To protect the electronic device, a coating is applied to the surface/substrate of the electronic device. In many cases, the coating is applied to improve surface properties of the substrate, such as appearance and adhesive properties. If the coating of the electronic device is too thin, the protection is reduced. If the coating of the electronic device is too thick, the surface properties of the electronic device are adversely influenced and the material of the coating is wasted. Therefore, testing the coating thickness of the electronic device before the electronic device leaves the factory to guarantee the coating thickness of the electronic device is important. However, the common method to test the coating thickness of the electronic device is by using a dedicated device, which is expensive.

A test device with a function of testing coating thickness and a test system to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic diagram of an embodiment of a test system with a function of measuring coating thickness.

FIG. 2 is a block diagram of an embodiment of a test device with function of measuring coating thickness.

FIG. 3 is a schematic diagram of a data line of a first embodiment applied in a test system, such as that of FIG. 1.

FIG. 4 is a schematic diagram of a data line of a second embodiment applied in a test system, such as that of FIG. 1.

FIG. 5 is a schematic diagram of a data line of a third embodiment applied in a test system, such as that of FIG. 1.

### DETAILED DESCRIPTION

Embodiments of the present disclosure will be described with reference to the accompanying drawings.

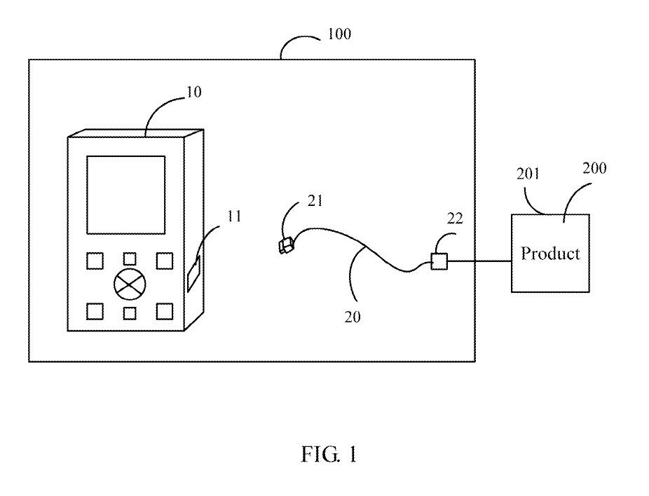

FIG. 1 illustrates a schematic diagram of a test system 100 with a function of testing coating thickness. The test system 100 is used to test a product 200 coated with a coating 201. In detail, the test system 100 is used to test a thickness of the coating 201 on a surface of the product 200. The test system 100 includes a test device 10 and a test line 20. The test device 10 includes a test port 11, and the test line 20 includes a test plug 21 and a test probe 22. The test plug 21 connects with the test port 11 of the test device 10, the test probe 22 contacts the coating 201 coated on the product 200 when testing the product 200.

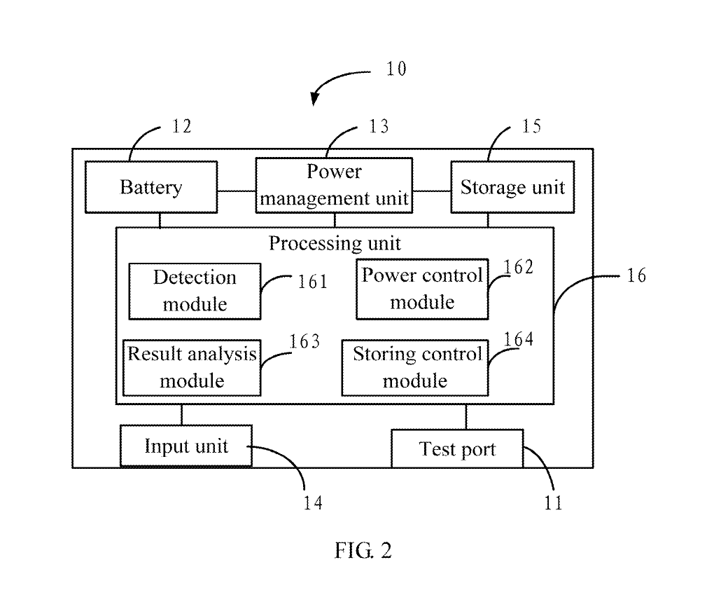

Referring also to FIG. 2, the test device 10 also includes a battery 12, a power management unit 13, an input unit 14, a storage unit 15, and a processing unit 16.

The battery 12 provides power. The power management unit 13 is used to distribute power from the battery 12 to the test device 10. The power management unit 13 is electrically connected to the test port 11. In the embodiment, the power management unit 13 distributes the power from the battery 12 to the test port 11.

The input port 14 generates signals in response to user input. The storage unit 15 stores electronic files, such as audio, video, and picture files. In the embodiment, the storage unit 15 is a built-in storage unit, such as a flash memory or a micro drive. In another embodiment, the storage unit 15 can be an external storage device, such as a USB flash disk.

The processing unit 16 is electrically connected to the power management unit 13 and the test port 11. The processing unit 16 includes a detection module 161, a power control module 162, a result analysis module 163, and a storing control module 164 which are programmed with a collection of software.

When the product 200 needs to be tested, the test plug 21 is connected to the test port 11 of the test device 10 and the test probe 22 is contacting the coating 201 of the product 200.

The detection module 161 detects whether the input unit 14 produces a test signal. For example, after the user connects the test plug 21 of the test line 20 with the test port 11 of the test device 10, and puts the test probe 22 on the coating 201 of the product 200 to contact the coating 201 of the product 200, the user can operate the input unit 14 to cause the input unit 14 to produce the test signal indicating that the test for the product 200 has begun.

The power control module 162 controls the power management unit 13 to distribute a power voltage to the test port 11 for a predetermined length of time, such as 2 seconds, when the detection module 161 detects the test signal. The power voltage provided to the test port 11 is then provided to the test probe 22 via the test line 20 connected to the test port 11.

The test probe 22 produces a stimulus signal when receiving the power voltage during the predetermined time, and produces a feedback signal including a particular reading when the test probe 22 stops receiving the power voltage, as hereinafter explained.

In the embodiment, the storage unit 15 also stores a relationship table defining relationships between a number of thicknesses of the coating and particular readings.

The result analysis module 163 detects the feedback signal from the test port 11 when the power management unit 13 stops distributing the power voltage to the test port 11. The result analysis module 163 is also used to obtain the particular reading in the feedback signal, and determines a thickness corresponding to the particular reading according to the relationship table and then produces a test result indicating the determined thickness of the coating 201. In detail, the result analysis module 163 determines the thickness corresponding to the particular reading obtained from the feedback signal according to the relationship between the particular reading obtained and the thicknesses defined in the relationship table.

The storing control module 164 stores the test result into the storage unit 13. For example, the storing control module 164 stores a test result table into the storage unit 13. The test result table includes name of the product 200 and the determined thickness of the coating 201 of the product 200.

In the embodiment, the test port 11 is a mini universal serial bus (USB) port, the power management unit 13 and the processing unit 16 are both connected to a power pin (not shown) of the mini USB port. In another embodiment, the test port 11 is a power port including a positive pin (not shown) and a negative pin (not shown), and the power management unit 13 and the processing unit 16 are both connected to the positive pin of the power port.

In the embodiment, the test device 10 can be a mobile phone, a digital photo frame, a tablet computer, a personal computer, or the like.

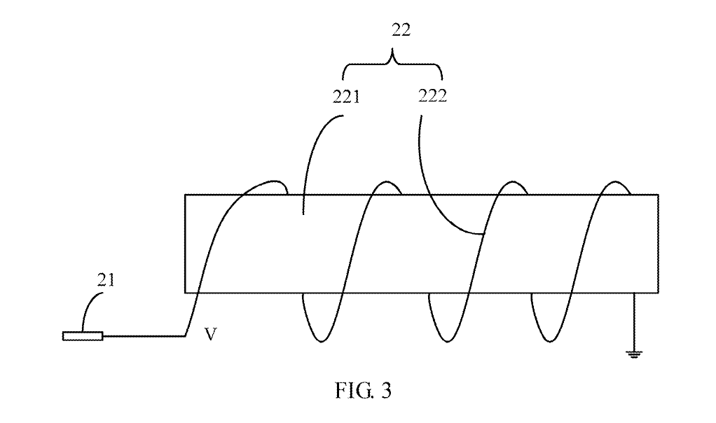

Referring also to FIG. 3, in the first embodiment, the test probe 22 of the test line 20 is a magnetic probe. In the embodiment, the test probe 22 includes a soft-core 221 and a coil 222 winding around the soft-core 221. The surface of the product 200 is made of a magnetic material and the coating 201 of the product 200 is a non magnetic coating on the surface of the product.

When the test probe 22 receives the power voltage via the test line, there is a current flowing through the coil 222 and causes the coil 222 to produce a magnetic field. When the power management unit 13 stops outputting the power voltage to the test port 11, the test probe 22 stops receiving the power voltage, thus the magnetic field of the coil 22 collapses. Therefore, a magnetic flux of the coil 222 is changed and the coil 222 produces an induced electromotive force V related to the thickness of the coating 201 due to the changed magnetic flux.

When the coating 201 is thicker, a resistance of the non-magnetic coating 201 is greater, and the value of the induced electromotive force is accordingly smaller. Thus, the value of the induced electromotive force produced by the coil 222 is related to the thickness of the coating 201 and reflects the thickness of the coating 201. In the embodiment, the value of the induced electromotive force V is contained as the particular reading in the feedback signal.

In the embodiment, the relationship table defines relationships between values of the induced electromotive force and thicknesses of the coating 201.

Thus, the result analysis module 163 obtains the value of the induced electromotive force V and determines the thickness of the coating 201 according to the relationships between the value of the induced electromotive force V and the thickness of the coating 201 defined in the relationship table.

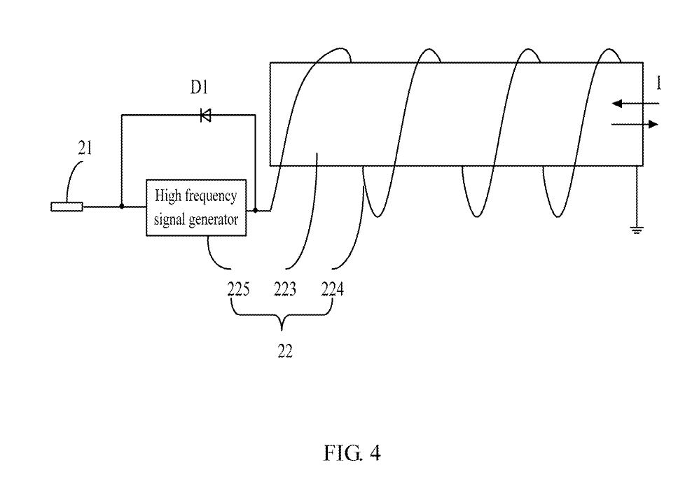

Referring to FIG. 4, a structure of the test probe 22 in the second embodiment is illustrated. In the second embodiment, the test probe 22 is a non magnetic probe, and includes an iron core 223 made of high-resonance frequency material, a coil 224 winding around the iron core 223, and a high frequency signal generator 225. The surface of the product 200 is made of a non-magnetic metal and the coating 201 of the product 200 is a dielectric coating on the surface of the product 200.

The high frequency signal generator 225 is connected between the coil 224 and the test plug 21 of the test line 20.

During the period of time for which the power management unit 13 distributes the power voltage to the test port 11, the power voltage is transmitted to the high frequency signal generator 225 via the test line 20 which connected to the test port 11 via the test plug 21. The high frequency signal generator 225 produces a high frequency signal when being powered and provides the high frequency signal to the coil 224. The coil 224 produces an electromagnetic field when receiving the high frequency signal and then produces an eddy current I related to the thickness of the coating 201.

The coil 224 feeds back the eddy current I to the test port 11 when the power management unit 13 stops distributing the power voltage to the test port 11.

As the coil 224 produces an electromagnetic field, when the test probe 22 is closer to the surface of the product 200, the eddy current I produced by the coil 224 is greater. Because the distance between the surface of the product 200 and the test probe 22 is exactly equal to the thickness of the coating 201 coated on the surface of the product 200, the value of the eddy current I is directly related to the thickness of the coating 201.

In the embodiment, the eddy current I is the feedback signal, and the value of the eddy current I is contained in the feedback signal as the particular reading. In the embodiment, the relationship table defines relationships between values of the eddy current I and thicknesses of the coating 201.

Therefore, the result analysis module 163 obtains the value of the eddy current I and determines the thickness of the coating 201 according to the relationships between the value of the eddy current I and the thickness of the coating 201.

As shown in FIG. 4, the test probe 22 also includes a diode D1, a cathode of the diode D1 is connected to the test plug 21 and an anode of the diode D1 is connected to the coil 224. Therefore, when the power management unit 13 distributes the power voltage to the test port 11, only the high frequency signal produced by the high frequency signal generator 225 is provided to the coil 224. When the power management unit 13 stops distributing the power voltage to the test port 11, the coil 224 feeds back the eddy current I to the test port 11 via the diode D1.

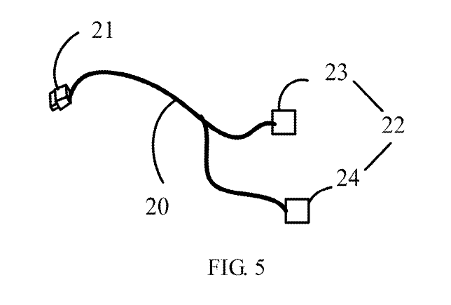

Referring to FIG. 5, in a third embodiment, the test probe 22 includes a magnetic probe 23 and a non magnetic probe 24. The magnetic probe 23 has the structure as shown in FIG. 3, and the non magnetic probe 24 has the structure as shown in FIG. 4.

The test probe 22 can test the thickness of the coating 201 coated on a product 200 which has a magnetic material surface via the magnetic probe 23 and also can test the thickness of the coating 201 on a product 200 which has a non-magnetic metal surface.

In the embodiment, the relationship table not only defines the relationships between the value of the induced electromotive force V and the thicknesses of the coating 201, but also defines the relationships between the value of the eddy current I and the thicknesses of the coating 201.

It is understood that the present embodiments and their advantages will be understood from the foregoing description, and various changes may be made thereto without departing from the spirit and scope of the disclosure or sacrificing all of its material advantages, the examples hereinbefore described merely being embodiments of the present disclosure.

What is claimed is:

1. A test system to measure coating thickness, the test system comprising a test device and a test line, the test line comprising a test plug and a test probe configured to contact a coating of a product to be tested, the test device comprising:
a test port configured to connect to the test plug of the test line;
a battery;
a power management unit configured to distribute power from the battery to the test device;
an input unit configured to generate signals in response to user input;
a storage unit storing a relationship table defining relationships between a number of thicknesses of the coating and particular readings; and
a processing unit comprising a detection module configured to detect whether the input unit produces a test signal, a power control module, and a result analysis module, wherein the power control module is configured to control the power management unit to distribute a power voltage to the test port and then transmit the power voltage to the test probe via the test line for a predetermined period of time, when the detection module detects the input unit produces the test signal; the test probe produces a stimulus signal when receiving the power voltage during the predetermined period of time, and produces a feedback signal including one particular reading when stopping receiving the power voltage; the result analysis module is configured to detect the feedback signal from the test port when the power management unit stops distributing the power voltage to the test port, obtain the particular reading of the feedback signal, determine a thickness corresponding to the particular reading according to the relationship table, and then produce a test result including the determined thickness of the coating.

2. The system according to claim 1, wherein the processing unit further comprises a storing control module configured to store the test result into the storage unit.

3. The system according to claim 1, wherein the test probe of the test line is a magnetic probe, the test probe comprises a soft-core and a first coil winding around the soft-core, a surface of the product is made of a magnetic material and the coating of the product is a non-magnetic coating on the surface of the product.

4. The system according to claim 3, wherein when the test probe receives the power voltage via the test line, there is a current flowing through the coil and causes the coil to produce a magnetic field; when the power management unit stops outputting the power voltage to the test port, the test probe stops receiving the power voltage, the magnetic field of the coil collapses, a magnetic flux of the coil is changed, and the coil produces an induced electromotive force related to the thickness of the coating due to the changed magnetic flux.

5. The system according to claim 4, wherein the induced electromotive force is the feedback signal, and a value of the induced electromotive force is contained as the particular reading of the feedback signal, and the relationship table defines relationships between values of the induced electromotive force and thicknesses of the coating.

6. The system according to claim 1, wherein the test probe is a non-magnetic probe; the test probe comprises an iron core made of high-resonance frequency material, a second coil winding around the iron core, and a high frequency signal generator; a surface of the product is made of a non-magnetic metal and the coating of the product is a dielectric coating on the surface of the product.

7. The system according to claim 6, wherein when the power management unit distributes the power voltage to the test port, the power voltage is transmitted to the high frequency signal generator via the test line which connected to the test port via the test plug; the high frequency signal generator produces a high frequency signal when being powered and provides the high frequency signal to the second coil; the second coil produces an electromagnetic field when receiving the high frequency signal and then produces an eddy current related to the thickness of the coating; the second coil further feeds back the eddy current to the test port when the power management unit stops distributing the power voltage to the test port.

8. The system according to claim 7, wherein the eddy current is the feedback signal, a value of the eddy current is contained as the particular reading of the feedback signal, and the relationship table defines relationships between values of the eddy current and thicknesses of the coating.

9. The system according to claim 1, wherein the test probe comprises both of the magnetic probe and the non-magnetic probe.

10. A test device to measure coating thickness, configured to test a coating on a product, the test device comprising:
a test port configured to connect to a test plug of a test line;
a battery, a power management unit configured to distribute power from the battery to the test device;
an input unit configured to generate signals in response to user input;
a storage unit storing a relationship table defining relationships between a number of thicknesses of the coating and particular reading; and
a processing unit comprising a detection module configured to detect whether the input unit produces a test signal, a power control module, and a result analysis module; wherein, the power control module is configured to control the power management unit to distribute a power voltage to the test port and then transmit the power voltage to the test probe via the test line for a predetermined time when the detection module detects the input unit produces the test signal; the test probe is caused to produce a stimulus signal when receiving the power voltage during the predetermined time, and produce a feedback signal including a particular reading when stopping receiving the power voltage; the result analysis module is configured to detect the feedback signal from the test port when the power management unit stops distributing the power voltage to the test port, obtain the particular reading of the feedback signal, determine a thickness corresponding to the particular reading according to the relationship table, and then produces a test result including the determined thickness of the coating.

11. The test device according to claim 10, wherein the processing unit further comprises a storing control module configured to store the test result into the storage unit.

12. The test device according to claim 10, wherein the feedback signal is an induced electromotive force, a value of the induced electromotive force is contained as the particular reading of the feedback signal, and the relationship table defines relationships between values of the induced electromotive force and thicknesses of the coating.

13. The test device according to claim 10, wherein the feedback signal is an eddy current, a value of the eddy current is contained as the particular reading of the feedback signal, and the relationship table defines relationships between values of the eddy current and thicknesses of the coating.

14. The test device according to claim 10, wherein, the test device is selected from the group consisting of a mobile phone, a tablet computer, and a digital photo frame.
